(19) United States
(12) Patent Application Publication
(10) Pub. No.: US 2006/0294188 A1
(43) Pub. Date: Dec. 28, 2006

(54) Providing status information about email recipients

(75) Inventors: Fonda J. Daniels, Cary, NC (US); Angela Richards Jones, Cary, NC (US); Kalena Charisee Kelly, Raleigh, NC (US); Ruthie D. Lyle, Durham, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/158,677

(22) Filed: Jun. 22, 2005

(51) Int. Cl. G06F 15/16

(52) U.S. Cl. 709/206

(57) ABSTRACT

A second email application and a third email application receive copies of an email sent by a first email application. In response to receiving the copy of the email, the second email application sends status information about the second email application to the third email application. The third email application provides an indicator that status information about the second email application is available.

### BACKGROUND

The invention applies generally to the field of electronic mail (email), and more particularly to providing status information such as out-of-office or “away” messages when multiple copies of an email are sent to a plurality of recipients.

Electronic mail systems can be highly responsive, in that an email can be sent to a recipient, a response composed by the recipient, and the response returned to the sender in a matter of very little time. Of course, the recipient of the message may delay his or her response if otherwise engaged when the incoming email arrives. In an extreme case, the response may be delayed quite some time if, for example, the recipient is out of the office for an extended period.

To lessen the problem of uncertain delay in the extreme case just mentioned, many email application programs provide a status tool that generates an automatic response to incoming email such as an “out-of-the-office” or “away” message. The status tool may be enabled by a user who expects to be unable to read or answer incoming email for an extended period of time. The away message informs the sender of an email that the intended recipient of the email will not be able to respond for some time, and often carries information that informs the sender of when the recipient will return to the office or otherwise be able to read or answer the sender's email.

Frequently, however, multiple copies of an email are sent to a multiplicity of recipients. For example, the user of a first email application program may send a copy of an email to the user of a second email application, and send another copy of the same email to the user of a third email application. If the user of the second email application is away, and has the status tool enabled, the second email application will inform the first email application that the second user is, for example, out of the office, and not expected to return for a week. The third user, however, has no way of knowing the status of the second user. This lack of awareness can be troublesome when information that is intended to be conveyed by the email has some degree of urgency.

### SUMMARY

The invention includes methods, systems, and computer instructions and program products for providing status information about email recipients.

In one aspect of the invention, a second email application and a third email application receive copies of an email sent by a first email application. In response to receiving the copy of the email, the second email application sends status information about the second email application to the third email application. The third email application receives the status information, and provides an indicator that status information about the second email application is available.

### BRIEF DESCRIPTION OF THE DRAWING

FIG. 1 shows aspects of a method for providing status information about email recipients.

### DETAILED DESCRIPTION

The present invention will now be described more fully hereinafter, with reference to the accompanying drawing, in which an illustrative embodiment of the invention is shown.

The invention may, however, be embodied in many different forms, and should not be construed as limited to the embodiment set forth herein; rather, this embodiment is provided so that the disclosure will be thorough and complete, and will fully convey the scope of the invention to those skilled in the art.

As will be appreciated by one of skill in the art, the present invention may be embodied as a method, data processing system, or computer program product. Accordingly, the present invention may take the form of an embodiment entirely in hardware, entirely in software, or in a combination of aspects in hardware and software referred to as circuits and modules.

Furthermore, the present invention may take the form of a computer program product on a computer-usable storage medium having computer-usable program code embodied in the medium. Any suitable computer-readable medium may be utilized, including hard disks, CD-ROMs, optical storage devices, magnetic storage devices, and transmission media such as those supporting the Internet or an intranet.

Computer program code for carrying out operations of the present invention may be written in an object oriented programming language such as Java7, Smalltalk, or C++. However, the computer program code for carrying out operations of the present invention may also be written in conventional procedural programming languages, such as the C programming language. The program code may execute entirely on the user's computer, partly on the user's computer, as a stand-alone software package, partly on the user's computer and partly on a remote computer, or entirely on a remote computer. The remote computer may be connected to the user's computer through a local area network or a wide area network, or the connection may be made to an external computer, for example through the Internet using an Internet Service Provider.

The present invention is described below with reference to a flowchart illustration. It will be understood that each block of the flowchart illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions and/or acts specified in the flowchart.

These computer program instructions may also be stored in a computer-readable memory that can direct a computer or other programmable data processing apparatus to function in a particular manner, such that the instructions stored in the computer readable memory produce an article of manufacture including instruction means which implement the functions or acts specified in the flowchart.

The computer program instructions may also be loaded onto a computer or other programmable data processing apparatus to cause a series of operations to be performed on the computer or other programmable apparatus to produce a computer implemented process such that the instructions that execute on the computer or other programmable apparatus provide steps for implementing the functions and/or acts specified in the flowchart.

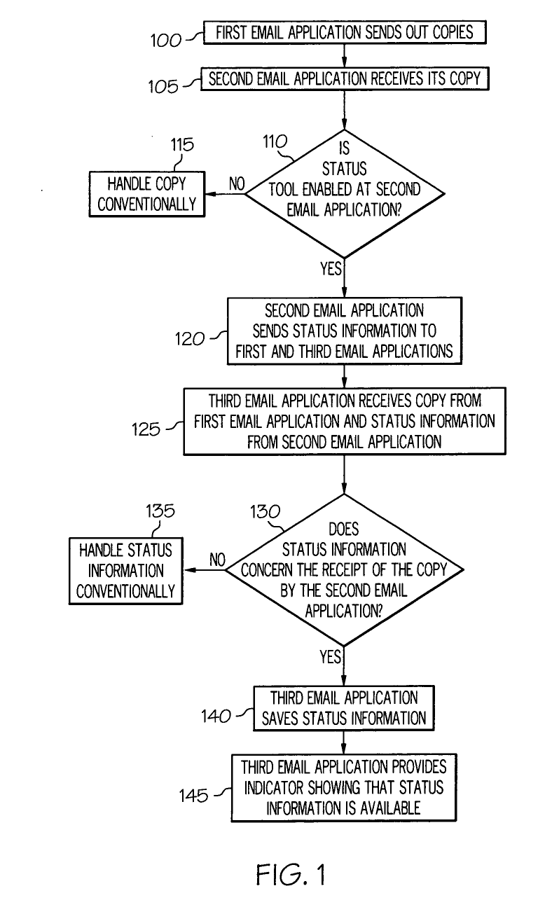

FIG. 1 shows aspects of a method for providing status information about email recipients, according to the invention, when copies of an email are sent to a plurality of recipients. One purpose of the invention is to enable the various recipients of the various copies of the email to become aware of each other's status. It is important to note that the invention is not limited to the teachings of the method of FIG. 1, however, and further includes, for example, computer instructions and computer program products for executing various operations of the method shown in FIG. 1, as described in the claims appended below.

As shown in FIG. 1, the user of a first email application program sends copies of an email to the user of a second email application program and to the user of a third email application program (block 100). Copies of the message may, of course, be sent to other users as well, and the invention encompasses these cases too. The discussion here is limited to one sender and two recipients only in the interest of descriptive clarity. Although the term “user” is employed here, this also is only in the interest of descriptive clarity, and the invention applies as well when the “user” is automated, or when the user is not physically present when the email application executes, as would be the case expected when the status tool is engaged to provide “away” messages.

A copy of the email message is received by the second email application (block 105). Upon receipt of the copy of the email, the second email application may create a line item in its in-box, so that the user of the second email application may be made aware that a new message has arrived.

The second email application determines whether its user has the status tool enabled (block 110), which may be enabled when, for example, the user is out of the office, as described above. If the status tool is not enabled, the second email application continues conventionally (block 115).

Otherwise (i.e., the status tool is enabled), status information is sent to the first email application and to the third email application regarding the status of the second email application (block 120). Here, the status information about the second email application may be, more literally, information about the status of the user of the second email application, such as a message indicating that the user of the second email application is on vacation, and out of the office for another week. Unlike conventional methods, the inventive method taught here sends the status information about the second email application to the third email application as well as to the first email application. Addresses needed to accomplish this may be derived in the same way that they are derived in a “reply-to-all” response, using, for example, the “carbon copy” list included in the email sent by the first email application.

The third email application receives a copy of the email sent by the first email application and a copy of the status information sent by the second email application (block 125). Generally, the third email application determines whether received status information concerns a recipient of a copy of email sent by another email application, or concerns instead email that the third email application has sent out itself (block 130). Under the particular circumstances discussed here, this determines whether the status information that the third email application receives from the second email application is responsive to another email that the third email application has sent to the second email application, which is called here “corresponding email,” or is responsive to the copy of the email sent by the first email application to the second email application. This may be determined by comparing addresses and time stamps, when available, or by message-arrival timing that takes network latency into account. In the latter case, the third email application may assume that status information received from the second email application within ten seconds, for example, of having sent email to the second email application concerns the email sent to the second email application rather than concerns a copy of the email sent out by the first email application.

If the status information concerns corresponding email, the status information is treated conventionally (block 135). For example, a line item may be created for display in the third email application's in-box showing an away message from the second email application.

Otherwise (i.e., the status information concerns a recipient of a copy of the email sent by the first email application), the third email application saves the status information (block 140), and provides an indicator (block 145), for the benefit of the user of the third email application, showing that status information is available concerning at least one other recipient of a copy of the email sent out by the first email application.

The indicator may be provided in a number of different ways. For example, in the in-box of the third email application, the indicator may be associated with a line item that indicates the arrival of the copy of the email sent by the first email application. When status information regarding another recipient of a copy of this email is available, the line item may so indicate by a field entry; or by an information bubble; or by changing, for example, the display color or font; by showing an icon in or near the line item; and so forth. The status information may be retrieved by the user of the third email application program by, for example, mouse-clicking the icon or a field of the line item; by hovering over the icon, field, or line item; and so forth. In other embodiments, the status information may be provided in the display of the text of the email message from the first email application. For example, when the email copy is opened by the third email application, the status information or an indication that status information is available may appear; or may be provided on demand, using, for example, an information bubble; and so forth.

Although the foregoing has described systems, methods, and computer program instructions and products for providing status information about email recipients, the description of the invention is illustrative rather than limiting; the invention is limited only by the claims that follow.

We claim:

1. A computer program product for providing status information about email recipients, the computer program product comprising a computer readable medium having computer readable program code embedded therein, the computer readable program code comprising:
computer readable program code configured to receive, by a second email application, a copy of an email sent by a first email application; and
computer readable program code configured to send status information about the second email application from the second email application to a third email application that also receives a copy of the email sent by the first email application.

2. The computer program product of claim 1, wherein the status information includes an away message.

3. A computer program product for providing status information about email recipients, the computer program product comprising a computer readable medium having computer readable program code embedded therein, the computer readable program code comprising:
computer readable program code configured to receive, by a third email application, a copy of an email sent by a first email application;
computer readable program code configured to receive, by the third email application, status information sent by a second email application in response to the second email application receiving a copy of the email sent by the first email application; and
computer readable program code configured provide an indicator, displayed by the third email application, that status information about the second email application is available.

4. The computer program product of claim 3, wherein the computer readable program code further comprises computer readable program code configured to determine, by the third email application, responsive to receiving status information sent by the second email application, whether the status information is responsive to reception, by the second email application, of a copy of the email sent by the first email application to the second email application;
wherein the computer readable program code configured provide an indicator provides the indicator on a condition that the status information is determined to be responsive to reception, by the second email application, of a copy of the email sent by the first email application to the second email application.

5. The computer program product of claim 3, wherein the indicator is provided by an in-box of the third email application.

6. The, computer program product of claim 5, wherein the indicator is associated with a line item indicating reception of the copy of the email from the first email application.

7. The computer program product of claim 3, wherein the indicator is provided in a display of text from the copy of the email received by the third email application.

8. The computer program product of claim 3, wherein the status information includes an away message.

9. A method for providing status information about an email recipient, comprising:
receiving, by a second email application, a copy of an email sent by a first email application;
receiving, by a third email application, a copy of the email sent by the first email application;
sending status information about the second email application from the second email application to the third email application, in response to the second email application receiving the copy of the email from the first email application;
receiving, by the third email application, the status information from the second email application; and
providing an indicator, by the third email application, that status information about the second email application is available.

10. The method of claim 9, further comprising:
determining, by the third email application, responsive to receiving status information sent by the second email application, whether the status information is responsive to the second email application receiving the copy of the email from the first email application; and providing the indicator only if it is determined that the status information is responsive to the second email application receiving the copy of the email from the first email application.

11. The method of claim 9, wherein the indicator is provided by an in-box of the third email application.

12. The method of claim 11, wherein the indicator is associated with a line item indicating reception of the copy of the email from the first email application.

13. The method of claim 9, wherein the indicator is provided in a display of text from the email received from the first email application.

14. The method of claim 9, wherein the status information includes an away message.
